(19) United States
(12) Patent Application Publication
(10) Pub. No.: US 2009/0216880 A1
(43) Pub. Date: Aug. 27, 2009

(54) Methods and Systems for Dynamic Transport Selection Based on Last Mile Network Detection

(75) Inventor: Peter Lepeska, Boston, MA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/391,654

(22) Filed: Feb. 24, 2009

Related U.S. Application Data
(60) Provisional application No. 61/031,510, filed on Feb. 26, 2008.

(51) Int. Cl. G06F 15/16; G06F 15/173

(52) U.S. Cl. 709/224; 709/230; 709/203

(57) ABSTRACT

The present invention relates to systems, apparatus, and methods of dynamic transport selection. The method includes determining link characteristics for a network connection between a client and a server. The link characteristics include a transport type and a connection type. The method further includes, based on the link characteristics, dynamically determining an optimal transport type, changing the transport type to the optimal transport type, and transmitting data between the client and the server using the optimal transport type.

### PRIORITY CLAIM

This application claims priority to U.S. Provisional Patent Application Ser. No. 61/031,510, filed Feb. 26, 2008, entitled “METHODS AND SYSTEMS FOR DYNAMIC TRANSPORT SELECTION BASED ON LAST MILE NETWORK DETECTION,” Attorney Docket No. 026841-001300US, which is hereby incorporated by reference herein in its entirety for any purpose.

### FIELD OF THE INVENTION

The present invention relates, in general, to network acceleration and, more particularly, to dynamic transport selection.

### BACKGROUND

Typically, when data is being transported over a network connection, the transport type used is static, meaning that, regardless of the type of data being transported, the characteristics of the link, etc., the same transport type is used. This can often be very inefficient and cause slow connection speeds and can waste resources. Hence, improvements in the art are needed.

### BRIEF SUMMARY

Embodiments of the present invention are directed to a method of performing dynamic transport selection. The method includes determining link characteristics for a network connection between a client and a server. The link characteristics include a transport type and a connection type. The method further includes, based on the link characteristics, dynamically determining an optimal transport type, changing the transport type to the optimal transport type, and transmitting data between the client and the server using the optimal transport type.

A further embodiment of the present invention includes a method for dynamic transport selection. The method includes receiving a network topology. The network topology includes blocks of internet protocol (IP) addresses. The method then, based on the network topology, determines a connection type associated with each of the blocks of IP addresses, wherein the connection type includes an associated transport type. Then, based on the connection type associated with each of the blocks of IP addresses, the method determines an optimal transport type of each of the blocks of IP addresses, and dynamically changes the associated transport type for each of the blocks of IP addresses to the determined optimal transport type.

According to further embodiments, a system for performing dynamic transport selection, is provided. The system includes a plurality of clients and a server coupled with each of the plurality of clients via a network connection between the server and each of the plurality of clients. The network connection includes a network type and a transport type. The server is configured to dynamically determine an optimal transport type for each of the plurality of clients, change the transport type to the optimal transport type for each of the plurality of clients, and transmit data to each of the plurality of clients using the optimal transport type.

In an alternative embodiment, a machine-readable medium is described. The machine-readable medium includes instructions for performing dynamic transport selection. The machine-readable medium includes instructions for determining link characteristics for a network connection between a client and a server. The link characteristics include a transport type and a connection type. The machine-readable medium further includes instructions based on the link characteristics, for dynamically determining an optimal transport type, changing the transport type to the optimal transport type, and transmitting data between the client and the server using the optimal transport type.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a flow diagram illustrating a method for performing dynamic transport selection, according to embodiments of the present invention.

FIG. 2 is a flow diagram illustrating a method for performing dynamic transport selection, according to a further embodiment of the present invention.

FIG. 3 is a block diagram illustrating a system of performing dynamic transport selection, according to one embodiment of the present invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

Aspects of the disclosure relate to dynamic transport selection based on link characteristics. Typically, when a client connects with a server (e.g., a file server, a web server, a mail server, etc.), the server only allows for the client to connect using one transport type (e.g., user datagram protocol (UDP), transmission control protocol (TCP), etc.). The transport type is statically assigned regardless of the type of client, type of connection the client is connecting to the server with, etc. In some instances certain clients connecting to the server using certain connection types would benefit from using a transport type other than the statically assigned “default” transport. Hence, the present invention allows for dynamic transport selection based on link characteristics, which allows each client's connection to the server to be optimized according to their links' specific characteristics.

In one embodiment, such dynamic transport selection may occur in the transport layer (4) of the 7-layer OSI model. The 7-layer OSI model includes (1) a physical link which controls transmission of the raw bitstream over a transmission medium (e.g., satellite link, DSL, cable modem, cellular connection, etc.). The model further includes the data-link layer (2) which ensures the reliability of the physical link. The network layer (3) establishes, maintains, and terminates network connection. The transport layer (4) encapsulates the upper three layers 5-7 (i.e., the session (5), the presentation (6), and the application (7) layers) from dealing with the complexities of the lower 1-3 layers (i.e., the transport layer (4) may be considered a “go-between” for the other layers). Hence, by optimally selecting the transport type for the transport layer (4), the client's connection can be significantly accelerated and/or optimized.

In a further embodiment, session layer (5) establishes, manages, and ends user connections. Furthermore, presentation layer (6) performs data transmissions to provide a common interface for applications. Finally, application layer (7) provides services directly to user applications.

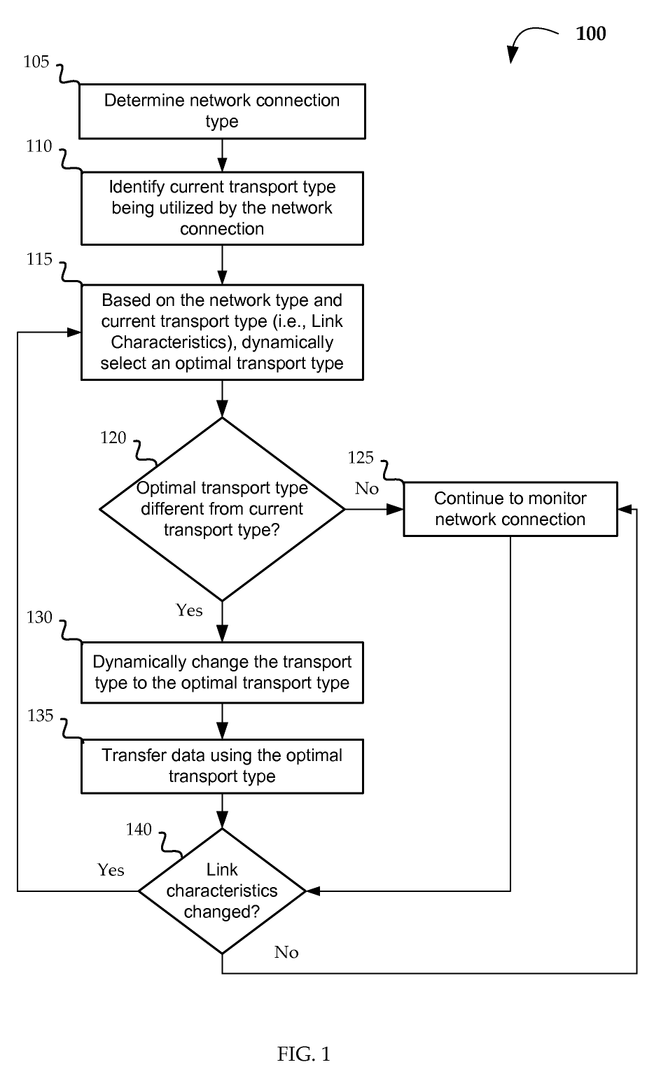

Turning now to FIG. 1, a method 100 is illustrated for dynamic transport selection according to embodiments of the present invention. In one embodiment, method 100 may be implemented in a network including a server (or cluster of servers) coupled with a variety of clients, each accessing the server (or servers) for data. Nonetheless, other network configurations may be used. For example, the network may be a server-mesh network, a hub and spoke network, and enterprise network, etc.

In one embodiment, the server, upon receiving a connection request from a client, may determine the connection type of the client (process block 105). In one embodiment, the connection type may be a satellite link, a Wi-Fi™ connection, a cellular connection, a cable modem connection, a broadband connection, a dial-up connection, digital subscriber line (DSL), integrated services digital network (ISDN), and evolution-data optimized (EVDO) connection; nonetheless, other connection types may be used by the client.

At process block 110, the current transport type being used to connect the server with the client is identified. In one embodiment, the transport type may be UDP, TCP, ITP, etc. The ITP transport protocol may be as described in U.S. Provisional Application No. 60/949,495, entitled METHODS AND SYSTEMS FOR BANDWIDTH MEASUREMENT, filed on Jul. 12, 2007, which is incorporated by reference herein for any and all purposes. In addition to identifying the current transport type, the server may also determine additional link characteristics for the connection between the client and the server. Some additional link characteristics may include congestion, the total number of clients connected to the server, the type of data the client is requesting, etc.

At process block 115, based on the connection type, current transport type, and other link characteristics, an optimal transport type may be dynamically selected. In one embodiment, the optimal transport type may be selected by comparing the link characteristic information with a table which includes a matrix which receives the link characteristics as input and outputs the optimal transport type.

For example, if the client is using a satellite connection or an EVDO connection to connect to the server, these connection types are not shared with multiple clients. Hence, each client can use as much of the connection's resources as possible, without negatively affecting other clients. In other words, with these types of connections (i.e., single client connections), clients can be “greedy” (i.e., use as much of the connection as possible) and do not need to be “share-friendly” (i.e., temper the use of the connection's resources). In this situation, UDP or ITP may be better suited for these clients because these transports continue to push more packets even when packets are being dropped (i.e., these transport protocols are “greedy” and will draw as much of the connection's resources as possible).

In contrast, some connections (e.g., cable modem, DSL) are shared by many clients. As such, clients with these types of connections cannot be “greedy” and need to be “share-friendly.” In one embodiment, these clients may use the TCP transport protocol. The TCP transport protocol will “back off” and slow the rate at which packets are pushed over the connection in response to dropped backs. In other words, TCP treats dropped packets as due to congestion, which effectively allows TCP to be “share-friendly” and work well on shared network connections. Accordingly, based on the link characteristics, an optimal transport type is selected for a given client.

At decision block 120, it is determined whether the current transport type differs from the optimal transport type. If the transport types are not different, then the connection between the client and the server is determined to be already optimized and no optimization is needed. At process block 125, the network connection's link characteristics are continued to be monitored until a change is detected (see decision block 140).

If it is determined that the current transport type and the optimal transport type are different, then the transport type of the connection is dynamically changed to the optimal transport type (process block 130). The change to the transport type may occur by the server transmitting a new connection request to the client using the optimal transport type. However, other methods may be used to change the connection type. In one embodiment, switching of transports is done seamlessly, and is transparent to the user. As such, a user may be using one transport type in one instance, and, without the knowledge of the user, another transport type in another instance.

At process block 135, data is transmitted between the client and the server using the optimal transport. In one embodiment, data is continued to be transmitted between the client and the server until the link characteristics of the connection between the client and the server changes (decision block 140). If the link characteristics change, then a new optimal transport type may be determined (process block 115). Otherwise, the network connection is continued to be monitored until a change occurs (process block 125).

In addition, once a transport type is chosen for the client, the individual transport protocol itself may be able to be optimized further. Therefore, based on the link characteristics, the server can make adjustments to the transport protocol further optimizing the connection between the client and the server.

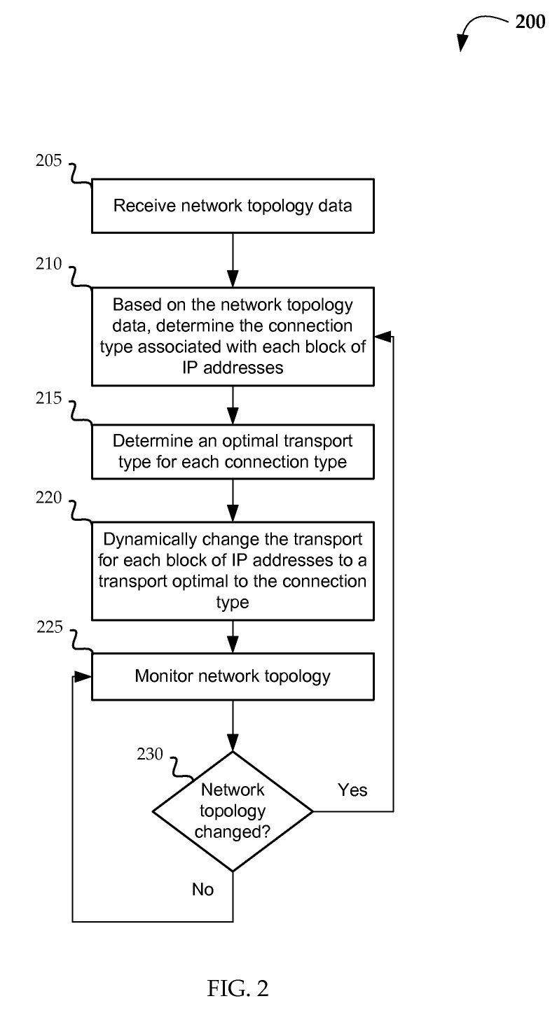

Referring now to FIG. 2, a method 200 is illustrated for dynamic transport selection according to another embodiment of the present invention. Typically, with enterprise network environments, blocks of Internet protocol (IP) addresses can be apportioned for use by certain types of connections. For example, a first block of IP addresses in an enterprise network environment may be for satellite clients, whereas a second block of IP addresses may be for EVDO clients, and yet a third clock of IP addresses may be for broadband clients. Hence, by identifying how IP addresses are apportioned for a given enterprise network, the connection type of the client connecting to the network can be determined based on the client's IP address.

Furthermore, some enterprises do not want unrecognizable ITP traffic running across their enterprise WAN. Such enterprises may prefer TCP because their network sniffers and/or quality of service (QoS) understand how to detect, parse, etc. TCP. Hence, for purely enterprise network policy considerations, some enterprises will require that certain clients (maybe, for example, only those clients connecting from a branch office as opposed to remote users) use TCP instead of ITP.

At process block 205, topology data, which includes IP address block connection designations, is received by a server. The server is then able to identify the connection type associated with each client connected to the server based on the topology information (process block 210). In one embodiment, this information may be stored in a database, a table, etc., so that it may be accessed by the server when needed.

At process block 215, the server may determine an optimal transport type to use for each connection type. In one embodiment, this determination may be made in a manner similar to that made in FIG. 1. Nonetheless, other methods of determining the optimal transport type for a given connection type may be used. In one embodiment, once the optimal transport type is determined for each connection type (i.e., each block of IP addresses), the transport type of the clients connecting to the server may be dynamically changed (process block 220). Hence, each client according to their individual connection type may be optimized to communicate with the server at the fastest rate possible for the connection type.

At process block 225, the network topology may continue to be monitored for changes to the topology itself or changes to the IP address block designations. In one embodiment, new clients may be added or removed from the network or IP address block designations may change. At decision block 230, the network topology is checked to determine if a change has been made. If it is determined that a change has not been made, then the network topology continues to be monitored (process block 225).

In contrast, if it is determined that the network topology has changed, then method 200 moves to process block 210, and the topology is re-analyzed. As a result, as the network topology changes and the link characteristics of each of the clients change, the transport type is able to be dynamically changed to consistently be optimized.

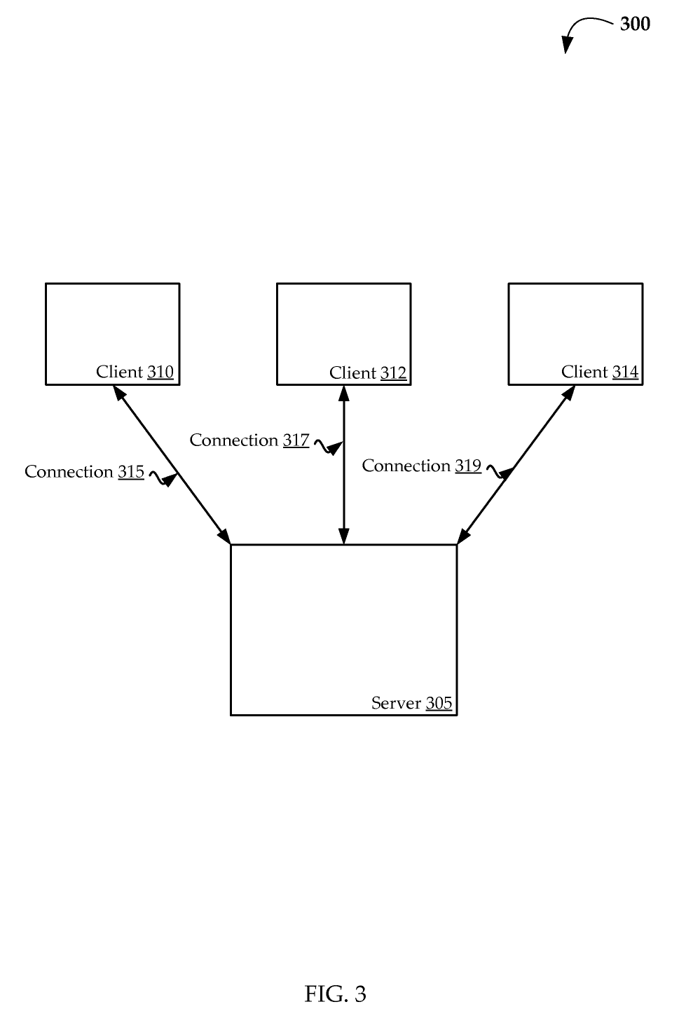

Turning now to FIG. 3, a system 300 is illustrated for dynamic transport selection according to embodiments of the present invention. In one embodiment, system 300 may include a server 305 (which may be a single server, multiple servers, a server farm, a mesh-server network, etc.). Server 305 may be connected to clients 310, 312, and 314 via connections 315, 317, and 319, respectively.

In one embodiment, server 305 may be a file server, a web server, a mail server, etc. Further, clients 310, 312, and 314 may be, for example, a mobile device, a cellular device, a personal digital assistant (PDA), a handheld device, a personal computer, a laptop computer, etc. In addition, connections 315, 317, and 319 may be a satellite link, a Wi-Fi™ connection, a cellular connection, a cable modem connection, a broadband connection, a dial-up connection, DSL, ISDN, and EVDO connection, etc.

In one embodiment, as server 305 receives a connection request from, for example, client 310, server 305 will determine the connection type and current transport type. Merely by way of example, connection 315 is a satellite link and the current transport type is TCP. Nonetheless, other connection types and/or transport types may be used. Based on the connection type and transport type (i.e., link characteristics), server 305 may choose an optimal transport type. In one embodiment, because the connection type is a satellite link, server 305 dynamically chooses ITP as an optimal transport type. In one embodiment, ITP is chosen for satellite links because ITP performs better than TCP with such high latency connections. This is because TCP has a “slow start” which means that TCP only gradually increases its send window over time. Also, TCP's send window maxes out at a value that is too low to completely utilize the satellite link's bandwidth. Whereas, ITP does not suffer from these shortcomings and is able to more fully utilize a satellite link's bandwidth capabilities. Thus, server 305, upon being switched to ITP, now uses the ITP transport to communicate with client 310.

In a further embodiment, merely by way of example, connection 317 is a DSL connection and the current transport type is UDP. In one embodiment, based on these link characteristics server 305 determines that it would be optimal for client 312 to use TCP instead of UDP. Accordingly, server 305 dynamically changes the transport protocol to TCP in order to optimize the connection between server 305 and client 312. Thus, based on the link characteristics of each of connections 315, 317, and 319, server 305 is able to optimize the connections.

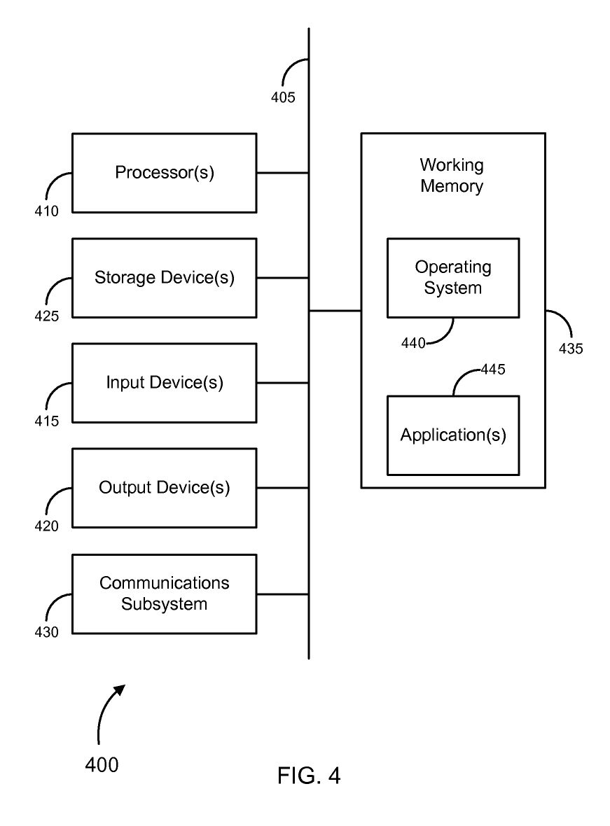

FIG. 4 provides a schematic illustration of one embodiment of a computer system 400 that can perform the methods of the invention, as described herein, and/or can function, for example, as any part of server 305 or clients 310, 312, or 314 of FIG. 3. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including without limitation one or more general-purpose processors and/or one or more special-purpose processors (such as digital signal processing chips, graphics acceleration chips, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation, dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

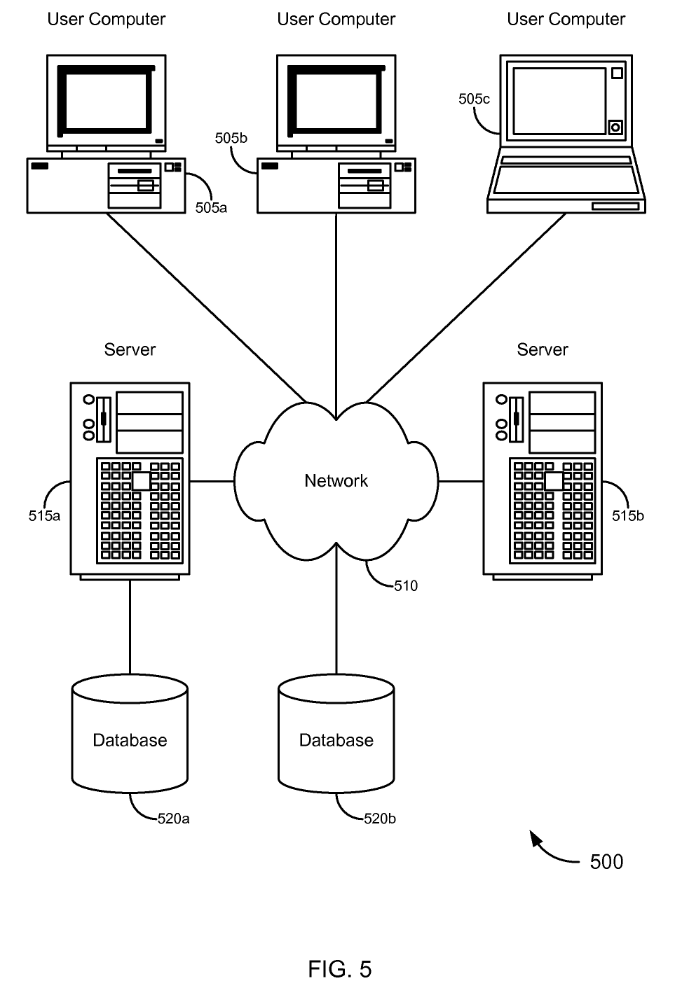

A set of embodiments comprises systems for implementing dynamic transport selection. In one embodiment, server 305 and/or clients 310, 312, or 314 (as shown in FIG. 3), may be implemented as computer system 400 in FIG. 4. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 505 and/or another server 515. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as the database can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of performing dynamic transport selection, the method comprising:
determining link characteristics for a network connection between a client and a server, wherein the link characteristics include a transport type and a connection type;
based on the link characteristics, dynamically determining an optimal transport type;
changing the transport type to the optimal transport type; and
transmitting data between the client and the server using the optimal transport type.

2. The method of performing dynamic transport selection according to claim 1, further comprising:
comparing the optimal transport type with the transport type; and
determining if the optimal transport type and the transport type are the same.

3. The method of performing dynamic transport selection according to claim 2, further comprising in response to the transport types being the same, continuing to monitor the network connection for changes in the link characteristics.

4. The method of performing dynamic transport selection according to claim 2, further comprising in response to the transport types being different, dynamically changing the transport type to the optimal transport type.

5. The method of performing dynamic transport selection according to claim 1, wherein the transport type and the optimal transport type are one or more of the following: user datagram protocol (UDP), transmission control protocol (TCP), and Intelligent Compression Technology Protocol (ITP).

6. The method of performing dynamic transport selection according to claim 1, wherein the determining of the optimal transport type comprises comparing the link characteristic information with a table which includes a matrix, wherein the matrix receives the link characteristics as input and outputs the optimal transport type.

7. A method of performing dynamic transport selection, the method comprising:
receiving a network topology, wherein the network topology includes blocks of internet protocol (IP) addresses;
based on the network topology, determining a connection type associated with each of the blocks of IP addresses, wherein the connection type includes an associated transport type;
based on the connection type associated with each of the blocks of IP addresses, determining an optimal transport type of each of the blocks of IP addresses; and
dynamically changing the associated transport type for each of the blocks of IP addresses to the determined optimal transport type.

8. A system for performing dynamic transport selection, the system comprising:
a plurality of clients; and
a server coupled with each of the plurality of clients via a network connection between the server and each of the plurality of clients, wherein the network connection includes a network type and a transport type, and the server is configured to dynamically determine an optimal transport type for each of the plurality of clients, to change the transport type to the optimal transport type for each of the plurality of clients, and to transmit data to each of the plurality of clients using the optimal transport type.

9. The system for performing dynamic transport selection according to claim 8, wherein the plurality of clients is at least one of the following: a mobile device, a cellular device, a handheld device, a smartphone, a personal computer, and a laptop computer.

10. The system for performing dynamic transport selection according to claim 8, wherein the network type includes one or more of a satellite link, a Wi-Fi connection, a cellular connection, a cable modem connection, a broadband connection, a dial-up connection, digital subscriber line (DSL), integrated services digital network (ISDN), and evolution-data optimized (EVDO) connection.

11. The system for performing dynamic transport selection according to claim 8, wherein the server is further configured to compare the optimal transport type with the transport type, and to determine if the optimal transport type and the transport type are the same.

12. The system for performing dynamic transport selection according to claim 11, wherein the server is further configured to, in response to the transport types being the same, continue to monitor the network connection for changes in the link characteristics.

13. The system for performing dynamic transport selection according to claim 12, wherein the server is further configured to, in response to the transport types being different, dynamically change the transport type to the optimal transport type.

14. The system for performing dynamic transport selection according to claim 8, wherein the transport type and the optimal transport type are one or more of the following: user datagram protocol (UDP), transmission control protocol (TCP), and Intelligent Compression Technology Protocol (ITP).

15. The system for performing dynamic transport selection according to claim 8, wherein the determining of the optimal transport type comprises comparing the link characteristic information with a table which includes a matrix, wherein the matrix receives the link characteristics as input and outputs the optimal transport type.

16. A machine-readable medium for performing dynamic transport selection, which includes sets of instructions stored thereon which, when executed by a machine, cause the machine to:
determine link characteristics for a network connection between a client and a server, wherein the link characteristics include a transport type and a connection type;
based on the link characteristics, dynamically determine an optimal transport type;
change the transport type to the optimal transport type; and
transmit data between the client and the server using the optimal transport type.

17. The machine-readable medium for performing dynamic transport selection according to claim 16, wherein the sets of instructions which, when further executed by the machine, cause the machine to:
compare the optimal transport type with the transport type;
determine if the optimal transport type and the transport type are the same; and
in response to the transport types being the same, continue to monitor the network connection for changes in the link characteristics.

18. The machine-readable medium for performing dynamic transport selection according to claim 17, wherein the sets of instructions, which, when further executed by the machine, cause the machine to, in response to the transport types being different, dynamically change the transport type to the optimal transport type.

19. The machine-readable medium for performing dynamic transport selection according to claim 16, wherein the transport type and the optimal transport type are one or more of the following: user datagram protocol (UDP), transmission control protocol (TCP), and Intelligent Compression Technology Protocol (ITP).

20. The machine-readable medium for performing dynamic transport selection according to claim 16, wherein the determining of the optimal transport type comprises comparing the link characteristic information with a table which includes a matrix, wherein the matrix receives the link characteristics as input and outputs the optimal transport type.
